(19) United States
(12) Patent Application Publication
(10) Pub. No.: US 2003/0201999 A1
(43) Pub. Date: Oct. 30, 2003

(54) Localized zoom system and method

(76) Inventors: Yi-Shin Lin, Shungchung City (TW); Chien-Fa Wang, Banciao City (TW)

Correspondence Address: RABIN & CHAMPAGNE, PC, 1101 14TH STREET, NW, SUITE 500, WASHINGTON, DC, 20005, US

(21) Appl. No.: 10/302,941

(22) Filed: Nov. 25, 2002

(30) Foreign Application Priority Data
Apr. 26, 2002 (TW) 91108747

(51) Int. Cl. G09G 5/00

(52) U.S. Cl. 345/660

(57) ABSTRACT

A system for localized zoom. The system includes a display device, a pointing device, a pointing device driver module and a display driver module. The pointing device has a corresponding pointer position and outputs a Min/Mag signal. The pointing device driver module determines a Min/Mag scale and a Min/Mag position according to the pointer position and the Min/Mag signal. The Min/Mag scale and the Min/Mag position are supplied to the display driver module by the pointing device driver module, and the display driver module assigns a graphic unit to display a corresponding overlapped region in the buffer memory onto the display device according to the Min/Mag scale and the Min/Mag position.

### BACKGROUND OF THE INVENTION

1. Field of the Invention

The present invention relates to a system and method for localized zoom, and particularly to a system and method that allows localized zoom in a display device through simple and easy operations.

2. Description of the Related Art

With the revolution of graphic accelerator, graphic chipsets and display devices, a variety of image resolutions may be selected in the display device.

For a display device with low resolution, the visible area is small. Objects may either overlap or can not be visible without interfering one another if there are too many objects in the viewing area. The visible area is large in a display device with high resolution, so there is no interference, but objects are displayed small, thus making them difficult to recognize.

For some other display devices, such as TVs, the displayed image may be blurred with high frequency. In addition, it is difficult for some disabled users to view the display device and locate the cursor of the pointing device.

### SUMMARY OF THE INVENTION

It is therefore an object of the present invention to provide a system and method that allows localized zoom in the display device through simple and easy operations.

To achieve the above objects, the present invention provides a system and method for localized zoom. According to one embodiment of the invention, the system for localized zoom includes a display device, a pointing device, a pointing device driver module, and a display driver module.

The pointing device has a corresponding pointer position and outputs a minification/magnification (abbreviated as Min/Mag) signal. The pointing device driver module determines a Min/Mag scale and a Min/Mag position according to the pointer position and the Min/Mag signal. The Min/Mag scale and the Min/Mag position are supplied to the display driver module by the pointing device driver module, and the display driver module assigns a graphic unit to display a corresponding overlapped region in the buffer memory onto the display device according to the Min/Mag scale and the Min/Mag position.

The pointing device further outputs a recovery signal, and the pointing device driver module notifies the display driver module to terminate display of the region in response to the recovery signal. Further, the pointing device further outputs a move signal, and the pointing device driver module resets the pointer position according to the move signal and the Min/Mag scale. The pointing device driver module adjusts the pointer position if the pointer position goes beyond the boundary.

Further, the display driver module sets a hardware pointer position. The pointing device driver module adjusts the Min/Mag position if the Min/Mag position goes beyond the boundary.

According to another embodiment of the invention, a method for localized zoom is provided. The method for localized zoom is suitable for use in a system with a pointing device driver module and a display driver module.

First, a Min/Mag scale and a Min/Mag position are determined by the pointing device driver module according to a pointer position corresponding to a pointing device and a Min/Mag signal. Then, the Min/Mag scale and the Min/Mag position are supplied to the display driver module by the pointing device driver module. Thereafter, a graphic unit is assigned by the display driver module to display a corresponding overlapped region in a buffer memory onto a display device according to the Min/Mag scale and the Min/Mag position.

Further, the display driver module is notified by the pointing device driver module to terminate display of the region in response to a recovery signal. The pointer position is reset by the pointing device driver module according to a move signal and the Min/Mag scale. The pointer position is adjusted by the pointing device driver module if the pointer position goes beyond the boundary.

Furthermore, a hardware pointer position is set by the display driver module. The Min/Mag position is adjusted by the pointing device driver module if the Min/Mag position goes beyond the boundary.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram showing the architecture of the system for the localized zoom according to the embodiment of the present invention;

FIG. 2 is a schematic diagram showing a pointing device that outputs the Min/Mag signal and the recovery signal;

FIG. 3 is a flowchart illustrating the operation of the pointing device driver module according to the embodiment of the present invention;

FIG. 4 is a flowchart illustrating the operation of the display driver module according to the embodiment of the present invention; and

FIG. 5 is a schematic diagram showing an example of the localized zoom according to the embodiment of the present invention.

### DETAILED DESCRIPTION OF THE INVENTION

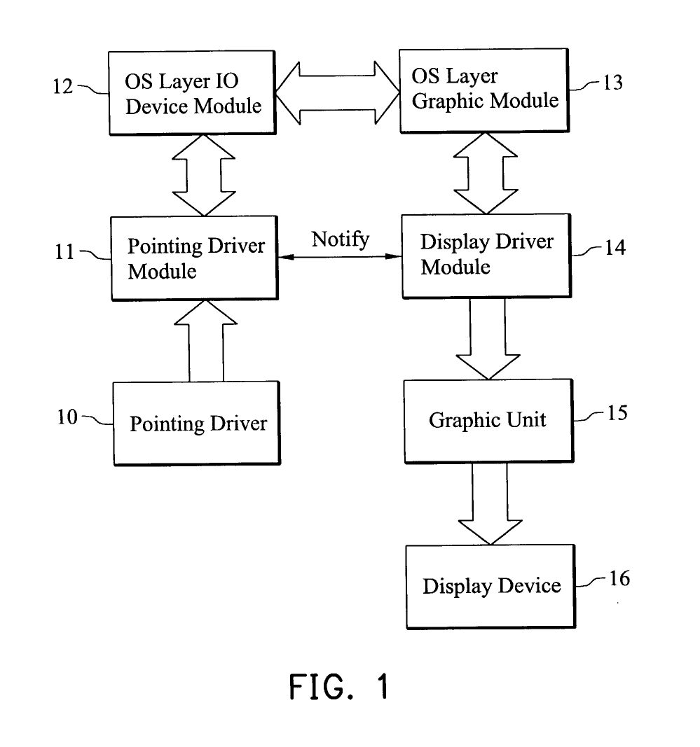

FIG. 1 is a schematic diagram showing the architecture of the system for localized zoom according to the embodiment of the present invention.

According to the embodiment of the invention, the system for localized zoom includes a pointing device 10, a pointing device driver module 11, an OS (Operating System) layer IO (Input/Output) device module 12, an OS layer graphic module 13, a display driver module 14, a graphic unit 15, and a display device 16.

The pointing device 10 may be a device to control the input or cursor position, such as a mouse pointer. The pointing device driver module 11 may be a driver to generate instructions corresponding to the action of the pointing device 10. The pointing device driver module 11 is installed in the system OS, and provides an interface between the pointing device 10 and the OS layer IO device module 12.

Similarly, the display driver module 14 is installed in the system OS, and the display driver module 14 provides an interface between the graphic unit 15 and the OS layer graphic module 13. The display driver module 14 may be a driver to control the operation of the graphic unit 15, and the graphic unit 15 may be a graphic accelerator or a graphic chipset. The OS layer graphic module 13 may set the picture to be rendered or assign the hardware pointer position (Hardware Cursor) in the graphic unit 15 through the display driver module 14, and the picture rendered by the graphic unit 15 is displayed in the display device 16.

In general, when the pointing device 10 is moved or a button there of is operated, an event of activating the pointing device 10 occurs. A signal corresponding to the event is then sent to the OS layer IO device module 12 in the system OS through the pointing device driver module 11. Thereafter, the signal received by the OS layer IO device module 12 is processed with some necessary calculation or transformation by the system OS. When the process is finished, the signal is forwarded to the OS layer graphic module 13 to set or assign the graphic unit 15 to perform corresponding operation through the display driver module 14.

When the pointing device 10 is operated with zoom function, the pointing device driver module 11 sends an event message to notify the display driver module 14 after the related signal and parameters are acquired by the pointing device driver module 11. Then, the display driver module 14 may assign the graphic unit 15 to overlapped display according to the event message. It should be noted that the present invention integrates the convenience of the pointing device for locating position and the overlapped display function of the graphic unit to zoom on arbitrary regions in the display device, so as to improve insufficiencies in the display.

The overlapped function of the graphic unit displays a desired picture over the original picture in the display device, but the data of the two pictures is still stored in their respective memories and is not changed or lost. Usually, this function is supported by most graphic chipsets. When this function is used, no retard or delay will occur on the display due to the massive data movement or process since the function is hardware-supported.

In order to employ the pointing device to perform zoom functions, a new control wheel is defined on the pointing device. By determining the wheel's direction, the region corresponding to the pointer position can be zoomed in or zoomed out. Further, a wheel button is added to the pointing device to reset the Min/Mag scale to an initial mode (Min/Mag scale equals 1), that is, to cancel the overlapped display function. In implementation, the new wheel and wheel button may be integrated to one structure.

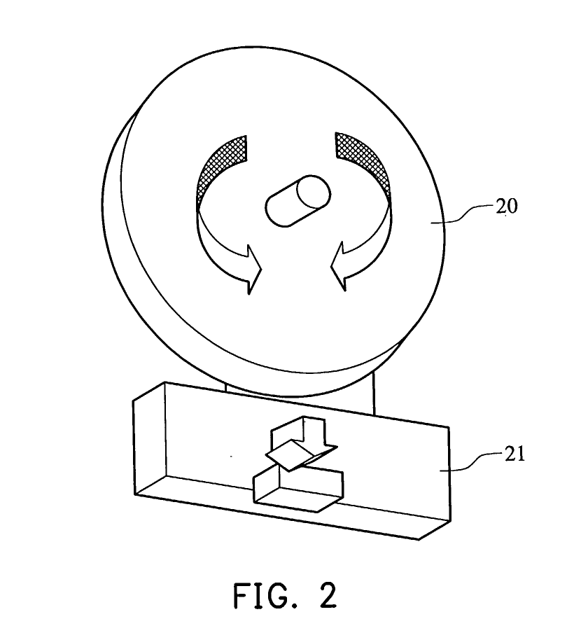

FIG. 2 is a schematic diagram showing a pointing device that outputs the Min/Mag signal and the recovery signal. In FIG. 2, the new wheel 20 and wheel button 21 are integrated to one structure. As shown in FIG. 2, the region is zoomed in on when the wheel 20 is rolled clockwise, and the region is zoomed out on when the wheel 20 is rolled counterclockwise. When the wheel 20 rolls, a Min/Mag signal is generated. When the wheel button 21 is pressed indirectly by pressing the wheel 20, a recovery signal is generated.

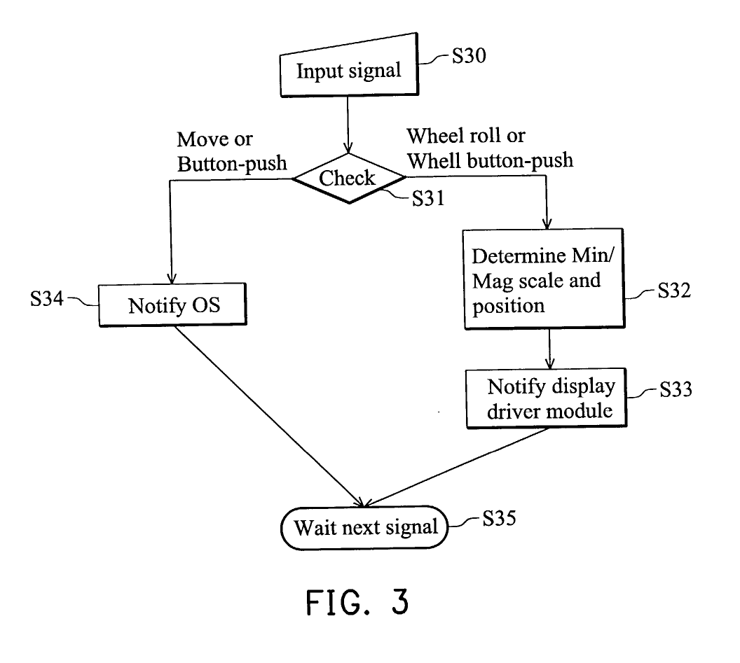

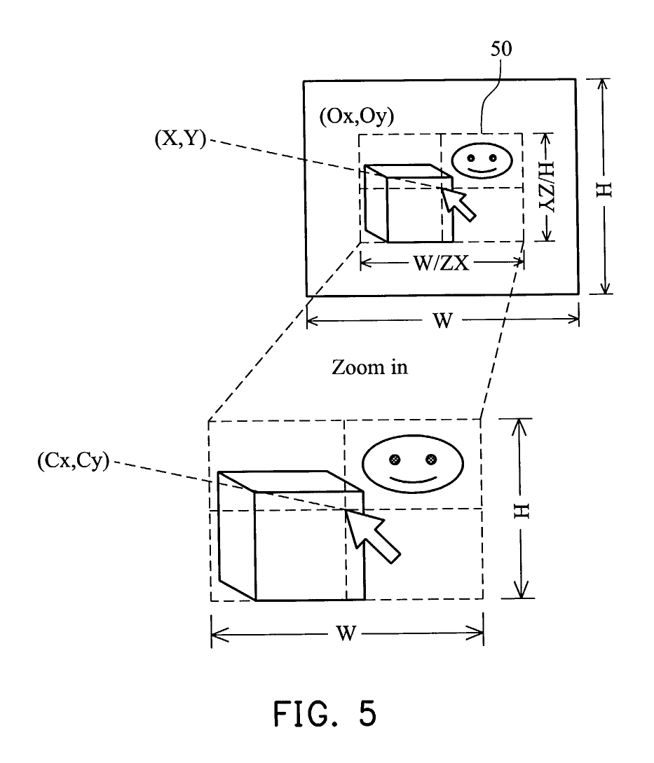

FIG. 5 is a schematic diagram showing an example of the localized zoom according to the embodiment of the present invention. In FIG. 5, the region overlaps the whole screen. FIG. 3 is a flowchart illustrating the operation of the pointing device driver module according to the embodiment of the present invention. First, in Step S30, a signal generated by the pointing device 10 is input. Then, in Step S31, the signal is checked whether it represents a prior move or button-push of the pointing device or a roll of the wheel or a wheel button-push according to the present invention.

If the signal represents a roll of the wheel or wheel button-push, in Step S32, a Min/Mag scale and a Min/Mag position are determined by the pointing device driver module 11 according to the current pointer position and the Min/Mag or recovery signal. The Min/Mag signal is determined according to the rolling direction and angle.

For example, the Min/Mag scale (ZX, ZY) includes two axes X axis and Y axis. If the wheel rolls clockwise for n units, the Min/Mag scale (ZX, ZY) equals,

X axis:ZX=ZX−(0.1*n); Y axis: ZY=ZY+(0.1*n).

On the contrary, if the wheel rolls counterclockwise for n units, the Min/Mag scale (ZX, ZY) equals,

X axis: ZX=ZX−(0.1*n); Y axis: ZY=ZY−(0.1*n).

In order to prevent the region being zoomed out on from being too small, the lower limit of the Min/Mag scale can set as 1, such that

X axis: ZX=MAX(ZX−(0.1*n),1); Y axis: ZY=MAX(ZY−(0.1*n),1).

It should be noted that the Min/Mag scale in X axis and in Y axis are set as equal in this embodiment. However, the Min/Mag scale in X axis and in Y axis may be different according to different applications, and the variation value of each unit (0.1) may also be different. In addition, the Min/Mag scale is set as 1 (ZX=1; ZY=1) if a recovery signal is received.

In addition, the Min/Mag position (Ox, Oy) is set as the coordinate of the furthest left side and top of the region to be zoomed in on or zoomed out on. In general, the Min/Mag position (Ox, Oy) equals,

Ox=X−(W/ZX)/2; Oy=Y−(H/ZY)/2),

the X and Y represent the X and Y coordinates of current pointer position; W represents the width displayed by the display device 16; H represents the height displayed by the display device 16. However, the Min/Mag position is adjusted if the Min/Mag position goes beyond the boundary of the display device 16. If Ox<0, Ox is set to 0; if Oy<0, Oy is set to 0; if (Ox+(W/ZX)) >W, Ox is set to W−(W/ZX); and if (Oy+(H/ZY))>H, Oy is set to H−(H/ZY).

After the Min/Mag scale and the Min/Mag position are determined, in Step S33, the Min/Mag scale and the Min/Mag position are sent (notified) to the display driver module 14. Then, in Step S35, the pointing device driver module 11 waits for another signal.

In addition, if the received signal represents move or button-push of the pointing device, in Step S34, the signal including the new position of the cursor is transferred to the OS layer IO device module 12, and then in Step S35, the pointing device driver module 11 waits for another signal. At the same time, the signal is further transferred to the display driver module 14 through the OS layer graphic module 13 by the OS layer IO device module 12.

It should be noted that the position of the cursor in the zoomed region and the actual position of the cursor in the original display may be different. Therefore, if the pointing device has an offset, AX and AY in X axis and Y axis respectively, the new position of cursor (Xnew, Ynew) in the zoomed in on or zoomed out on region equals,

Xnew=X+ΔX′; Ynew=Y+ΔY′, the ΔX′=ΔX/ZX; ΔY=ΔY/ZY.

The pointer position is adjusted if the pointer position goes beyond the boundary of the display device 16. If Xnew <Ox, Xnew is set to Ox; if Ynew <Oy, Ynew is set to Oy; if Xnew>(Ox+(W/ZX)), Xnew is set to Ox+(W/ZX); and if Ynew>(Oy+(H/ZY)), Ynew is set to Oy+(H/ZY).

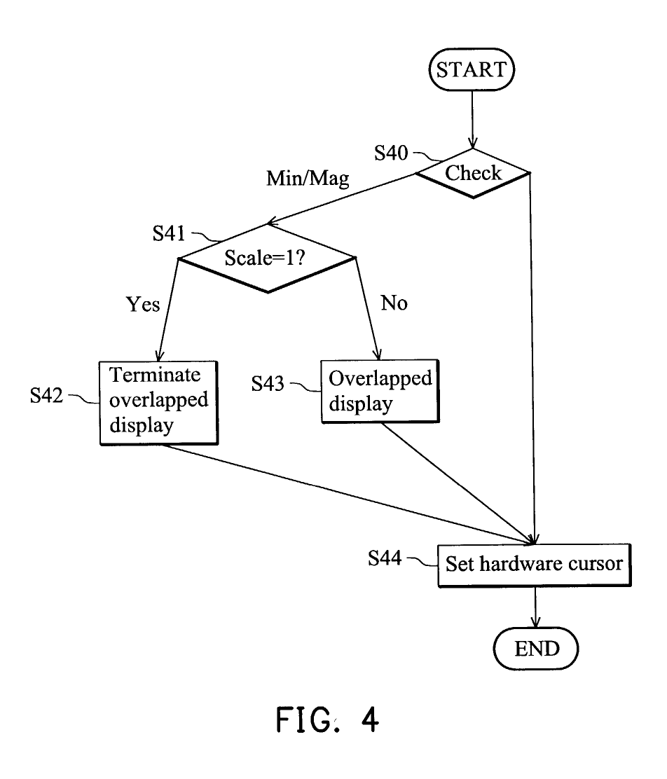

FIG. 4 is a flowchart illustrating the operation of the display driver module according to the embodiment of the present invention.

First, in Step S40, a received signal is assessed as to whether it represents a zoom or move instruction. If the signal is a zoom instruction, then in Step S41, the Min/Mag scale is checked. If the Min/Mag scale equals 1 (the signal is a recovery signal), then in Step S42, the overlapped display region is terminated. If the Min/Mag scale does not equal 1, then in Step S43, the graphic unit 15 is assigned by the display driver module 14 to display a corresponding overlapped region in a buffer memory (not shown) to the display device 16 according to the Min/Mag scale and the Min/Mag position. Thereafter, in Step S44, a hardware pointer position (Cx, Cy) (hardware cursor) is set as,

Cx=(X−Ox)*ZX; Cy=(Y−Oy)*ZY.

If the signal is a move instruction, then in Step S44, the hardware pointer position (Cx, Cy) (hardware cursor) is set as,

Cx=(Xnew −Ox)*ZX; Cy=(Ynew−Oy)*ZY.

It should be noted that the users can select objects in the zoomed region without any inaccuracy by setting the hardware cursor.

As a result, using the system and method for localized zoom according to the present invention, local regions may be zoomed to display in the display device through simple and easy operations.

Although the present invention has been described in its preferred embodiment, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A system for localized zoom, comprising:
a display device;
a pointing device with a corresponding pointer position and outputting a Min/Mag signal;
a pointing device driver module to receive the Min/Mag signal, determine a Min/Mag scale and a Min/Mag position according to the pointer position and the Min/Mag signal, and output the Min/Mag scale and the Min/Mag position; and
a display driver module to receive the Min/Mag scale and the Min/Mag position, assign a graphic unit to display a corresponding overlapped region in a buffer memory onto the display device according to the Min/Mag scale and the Min/Mag position.

2. The system as claimed in claim 1 wherein the display driver module further sets a hardware cursor.

3. The system as claimed in claim 1 wherein the pointing device further outputs a recovery signal.

4. The system as claimed in claim 3 wherein the display driver module is further notified by the pointing device driver module to terminate display of the region in response to the recovery signal.

5. The system as claimed in claim 1 wherein the pointing device driver module further adjusts the Min/Mag position if the Min/Mag position goes beyond the boundary of the display device.

6. The system as claimed in claim 1 wherein the pointing device further outputs a move signal.

7. The system as claimed in claim 6 wherein the pointing device driver module resets the pointer position according to the move signal and the Min/Mag scale.

8. The system as claimed in claim 7 wherein the pointing device driver module further adjusts the pointer position if the pointer position goes beyond the boundary of the display device.

9. A method for localized zoom for use in a system with a pointing device driver module and a display driver module, comprising the steps of:
determining a Min/Mag scale and a Min/Mag position by the pointing device driver module according to a pointer position corresponding to a pointing device and a Min/Mag signal;
supplying the Min/Mag scale and the Min/Mag position to the display driver module by the pointing device driver module; and
assigning a graphic unit by the display driver module to display a corresponding overlapped region in a buffer memory onto a display device according to the Min/Mag scale and the Min/Mag position.

10. The method as claimed in claim 9 further comprising the step of setting a hardware cursor by the display driver module.

11. The method as claimed in claim 9 further comprising the step of notifying the display driver module by the pointing device driver module to terminate display of the region in response to a recovery signal.

12. The method as claimed in claim 9 further comprising the step of adjusting the Min/Mag position by the pointing device driver module if the Min/Mag position goes beyond the boundary of the display device.

13. The method as claimed in claim 9 further comprising the step of resetting the pointer position by the pointing device driver module according to a move signal output by the pointing device and the Min/Mag scale.

14. The method as claimed in claim 13 further comprising the step of adjusting the pointer position by the pointing device driver module if the pointer position goes beyond the boundary of the display device.
